(19) United States
(12) Patent Application Publication
(10) Pub. No.: US 2009/0257305 A1
(43) Pub. Date: Oct. 15, 2009

(54) APPARATUS FOR SEPARATING SPRINGS

(75) Inventors: CHIEN-YEN TU, Tu-Cheng (TW); CHIH-CHIEN TSAI, Tu-Cheng (TW); YU-CHIEH LIAO, Tu-Cheng (TW); CHAU-LIN CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXNUM TECHNOLOGY CO., LTD., Tucheng City (TW)

(21) Appl. No.: 12/210,506

(22) Filed: Sep. 15, 2008

(30) Foreign Application Priority Data
Apr. 11, 2008 (TW) 97113222

(51) Int. Cl. B01F 13/02

(52) U.S. Cl. 366/107

(57) ABSTRACT

An apparatus for separating springs includes a hollow casing, first and second tubes, and a plate. The casing defines an entrance hole allowing springs to enter, and an exit hole allowing springs to exit. The first tube has one end connected to a bottom of the casing, allowing gas to be introduced into the casing. The second tube has one end connected to a middle of the casing opposite to the hole, allowing gas to be introduced into the casing. The plate is fixed to the bottom of the casing for supporting the springs. The plate is ventilated, and is located above the end of the first tube.

### BACKGROUND

1. Field of the Invention

The present invention generally relates to handing apparatus, and particularly to an apparatus for separating entangled springs.

2. Description of Related Art

Mass-produced springs are often packed together without any means for keeping them separate. The springs tend to mesh with coils of other springs, thereby becoming difficult to separate when unpacked. A typical machine for separating the springs includes a motor and a plate fixed to the axle of the motor. Two protrusions are fixed on the plate. When the motor operates, the plate is driven to rotate, and the protrusions agitate the springs on the plate, and separate the springs.

Such a machine, driven by electricity, expends excess energy.

### SUMMARY

An apparatus for separating springs includes a hollow casing, first and second tubes, and a plate. The casing defines an entrance hole allowing springs to enter, and an exit hole allowing springs to exit. The first tube has one end connected to a bottom of the casing, allowing gas to be introduced into the casing. The second tube has one end connected to a middle of the casing opposite to the hole, allowing gas to be introduced into the casing. The plate is fixed to the bottom of the casing for supporting the springs. The plate is ventilated, and is located above the end of the first tube.

### BRIEF DESCRIPTION OF THE DRAWINGS

FIG. 1 is an isometric view of an apparatus for separating springs in accordance with a first exemplary embodiment of the present disclosure, the apparatus including a plate.

FIG. 2 is an isometric, cutaway view of the plate of FIG. 1.

FIG. 3 is an isometric view of a plate according to a second embodiment.

FIG. 4 is an isometric view of a plate according to a third embodiment.

### DETAILED DESCRIPTION

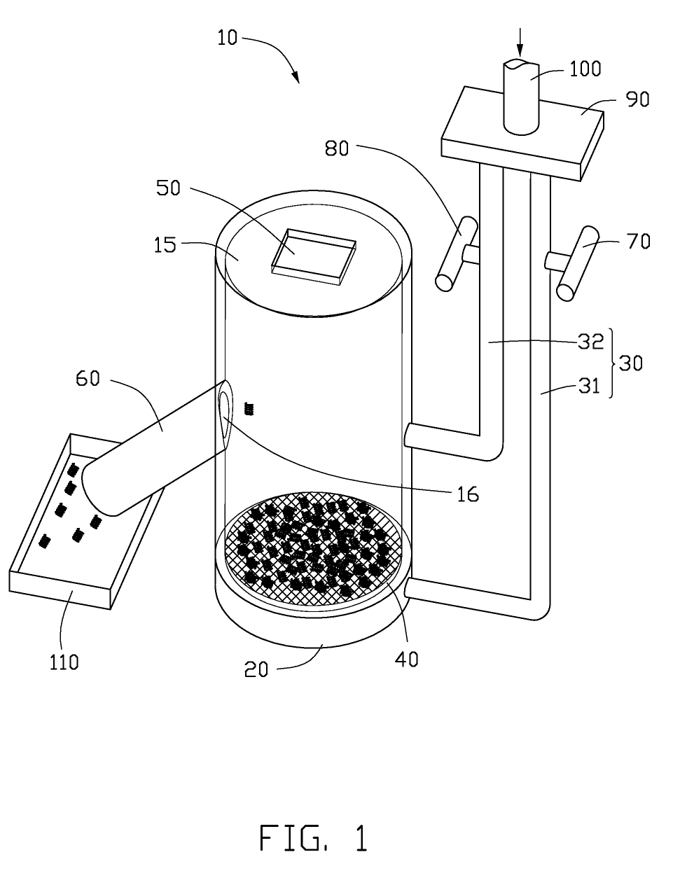

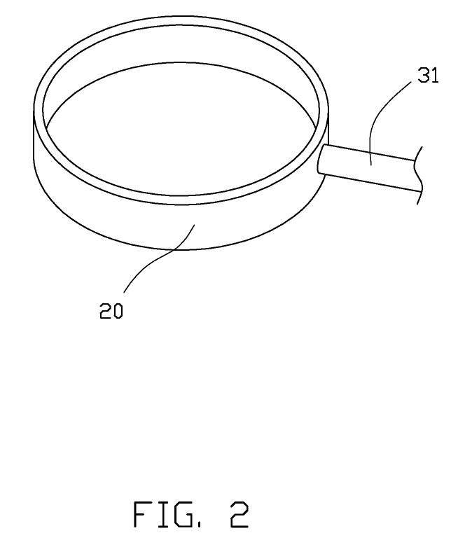

Referring to FIG. 1 and FIG. 2, an apparatus 10 for separating springs includes a casing 15, a base 20, a plate 40, and a gas feeder 30.

The casing 15 is generally cylindrical and hollow. A top of the casing 15 defines an entrance hole 50, allowing a plurality of entangled springs to enter the casing 15. The casing 15 defines an exit hole 16 in a middle of its circumference, to communicate the inner space of the casing 15 with that of a sleeve 60. Opposite the exit hole 16, the casing 15 defines a gas hole (not shown) connected to the gas feeder 30.

The base 20 is also hollow and the same shape as the casing 15. The base 20 has a bottom and a sidewall and is open at the top thereof. The base 20 is fixed at the top to a bottom of the casing 15. A through hole is defined in the sidewall of the base 20.

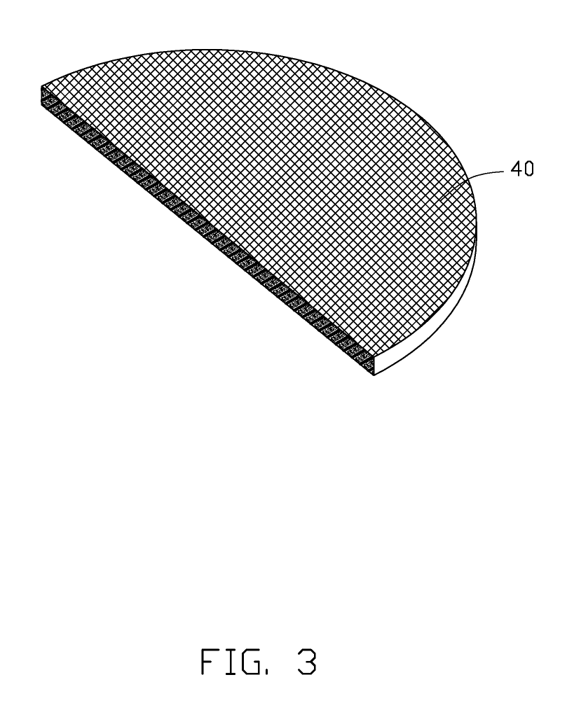

With reference to FIG. 3, the plate 40 is mounted to cover the open top of the base 20 and located in the casing 15. The plate 40 is ventilated to allow gas to pass therethrough. In this embodiment, the plate 40 is an evenly porous material allowing gas to pass through from the base 20 and be evenly distributed throughout the inner space of the casing 15.

The gas feeder 30 includes a first tube 31 and a second tube 32. One end of the first tube 31 is engaged in the through hole of the base 20 to allow gas to pass into the hollow of the base 20, and one end of the second tube 32 is engaged in the gas hole of the casing 15. A first valve 70 is fixed to the first tube 31, and a second valve 80 is fixed to the second tube 32, allowing adjustment of gas flow in the first tube 31 and the second tube 32, respectively. The settings of the first valve 70 and the second valve 80 depend on the weight of the springs to be separated. The opposite ends of the first and second tubes 31, 32 are connected to a divider 90, which is further connected to a gas entrance 100 through which the gas is provided. The divider 90 provides the gas from the gas entrance 100 to the first tube 31 and the second tube 32, respectively.

In operation, entangled springs enter the casing 15 through the entrance hole 50 and supported on the plate 40. As the gas is provided through the gas entrance 100, the entangled springs on the plate 40 are impelled by the gas delivered to the hollow of the base 20 and flowing through the plate 40, and are agitated thereby, eventually separating from one another. Once separated, single springs are light enough to be airborne to a height of the exit hole 16 and the gas hole of the casing 15, and thus be introduced out of the casing 15 through the exit hole 16 of the casing 15 and the sleeve 60, by gas flowing from the second tube 32 through the gas hole of the casing 15. The springs ejected from the casing 15 can subsequently be captured in a container 110 positioned at the sleeve 60. The rate of gas flow through the base 20 and the plate 40 can be adjusted according to the weight of the springs, such that still-entangled springs are too heavy to be elevated to the height of the exit hole 16 and gas hole of the casing 15, but can be elevated sufficiently to tumble effectively, by manipulation of the first valve 70.

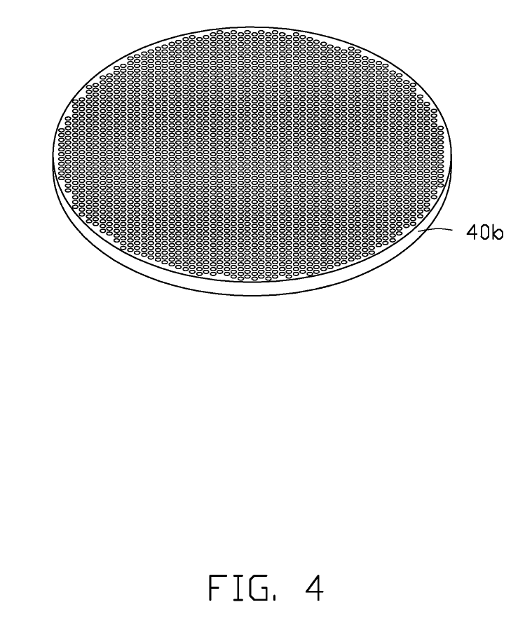

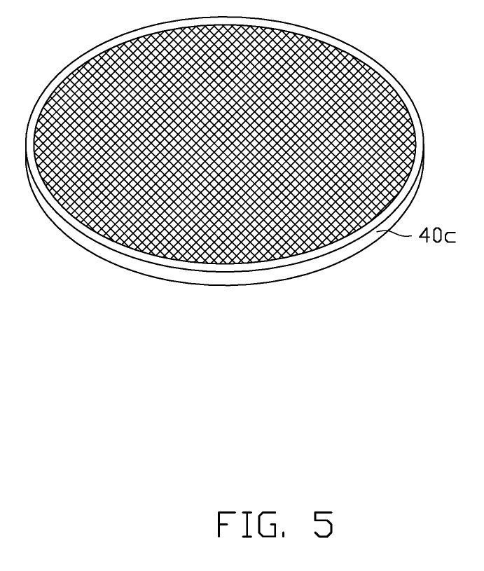

Referring to FIG. 4, in a second exemplary embodiment, the plate 40b is acryl or similar material and regularly defines a plurality of circular holes

Referring to FIG. 5, in a third exemplary embodiment, the plate 40c is acryl or similar material and regularly defines a plurality of quadrate holes.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An apparatus for separating springs comprising:
a hollow casing defining an entrance hole allowing springs to enter and an exit hole allowing springs to exit;
a first tube with one end connected to a bottom of the casing allowing gas to be introduced into the casing;
a second tube with one end connected to a middle of the casing opposite to the exit hole, allowing gas to be introduced into the casing; and
a plate fixed to the bottom of the casing for supporting the springs, wherein the plate is ventilated and located above the end of the first tube.

2. The apparatus of claim 1, wherein the exit hole is defined in a middle of a circumference of the casing.

3. The apparatus of claim 1, wherein the first tube is configured for introducing gas into the bottom of the casing, to agitate the springs on the plate up and down.

4. The apparatus of claim 3, further comprising a valve fixed to the first tube, wherein the valve is configured for adjusting gas speed in the first tube, sufficient to elevate separated springs in the casing to the height of the exit hole.

5. The apparatus of claim 4, further comprising another valve fixed to the second tube, configured for adjusting gas flow in the second tube to be sufficient to elevate separated springs to the height of the exit hole by the gas from the first tube out of the casing through the exit hole.

6. The apparatus of claim 1, further comprising a base fixed to the bottom of the casing, wherein the base defines a receiving space communicating with the first tube, the plate fixed to the base and located in the casing, covering the receiving space.

7. The apparatus of claim 1, wherein the plate is porous material.

8. The apparatus of claim 1, wherein the plate is acryl.

9. The apparatus of claim 8, wherein the plate defines a plurality of circular holes.

10. The apparatus of claim 8, wherein the plate defines a plurality of quadrate holes.

11. The apparatus of in claim 1, wherein the first tube and the second tube are connected to a divider which isolates gas provided.

12. The apparatus of claim 11, wherein the divider is connected to a gas entrance allowing external gas to enter.
